(19) United States
(12) Patent Application Publication
(10) Pub. No.: US 2025/0283556 A1
(43) Pub. Date: Sep. 11, 2025

(54) METHOD FOR IMPLEMENTING A DATA-BASED POSITION SENSOR FOR AN ELECTROMAGNETICALLY ACTUATED COMPONENT, FLUID VALVE AND FLUID SYSTEM

(71) Applicant: HAWE Hydraulik SE, Aschheim (DE)

(72) Inventors: Fabian Kreutmayr, Aschheim (DE); Markus Imlauer, Aschheim (DE); Andreas Jell, Aschheim (DE)

(73) Assignee: HAWE Hydraulik SE, Aschheim (DE)

(21) Appl. No.: 19/072,197

(22) Filed: Mar. 6, 2025

(30) Foreign Application Priority Data
Mar. 8, 2024 (DE) 10 2024 202 183.0

(51) Int. Cl. F16K 37/00; G06N 20/00

(52) U.S. Cl. CPC F16K 37/0041; G06N 20/00

(57) ABSTRACT

A method for implementing a data-based position sensor for an electromagnetically actuated component is provided. The data-based position sensor comprises a prediction model for the position of an electromagnetically actuated element of the electromagnetically actuated component. In the method, a training data set is generated using the electromagnetically actuated component and the prediction model is trained using the training data set. In particular, this makes it possible to determine the position of a valve element of an electromagnetically actuated fluid valve, which comprises only one electromagnet for actuating the valve element, without the use of hardware sensors for position measurement.

### CROSS REFERENCE TO RELATED APPLICATION

This application claims the priority benefit from German Patent Application No. 10 2024 202 183.0, filed on Mar. 8, 2024, the entire contents of which is incorporated herein by reference in its entirety.

### FIELD

The present disclosure relates to a method for implementing a data-based position sensor for an electromagnetically actuated component, in particular an electromagnetically actuated fluid valve, a method for determining the position of an armature of an individual electromagnet of a specific electromagnet type, a method for determining the position of a valve element of an individual electromagnetically actuated fluid valve of a specific fluid valve type, a fluid valve with a data-based position sensor and a fluid system.

### BACKGROUND

A fluid system within the meaning of the present disclosure can be a hydraulic system or a pneumatic system. A fluid valve can accordingly be configured as a hydraulic valve or as a pneumatic valve.

In fluid systems, for example in hydraulic systems, the parameters pressure and volume flow are decisive for the respective application. The pressures prevailing in such fluid systems can be detected relatively easily and inexpensively using appropriate hardware sensors and processed via corresponding electronic control or regulation units. Hardware sensors for volume flows, on the other hand, are usually complex and expensive to implement, which is why they are not an option for many applications for economic reasons.

The volume flows in a fluid system are usually set via fluid valves. By moving a valve element of such a fluid valve, the opening cross-section of the fluid valve is changed and a volume flow dependent on the opening cross-section is made available via the fluid valve. The volume flow flowing via the fluid valve is therefore directly dependent on the position of the valve element. In electromagnetically actuated fluid valves, which comprise an electromagnet with a coil and an armature for actuating the valve element, the movement and therefore the positioning of the valve element is achieved by energizing the coil with an actuating current and the resulting movement and positioning of the armature within the coil.

The opening cross-section of such a fluid valve depends primarily on the current flow through the electromagnet, so that the electronic control unit can basically regulate the volume flow through the fluid valve by controlling the current flow through the electromagnet. However, the actual opening cross-section of the fluid valve also depends on other parameters such as hysteresis effects, friction effects, a system pressure or temperatures such as the ambient temperature and the system temperature. These disturbance variables can lead to a control error, which is fundamentally undesirable and should be compensated for. For this purpose, independent position sensors for monitoring the position of the valve element and downstream control loops are regularly used in the state of the art. Depending on the measuring principle, modern position sensors have two to three coils for detecting the position of an armature within the coils. This enables the use of temperature-independent measuring principles and thus ensures a high temporal and spatial resolution in position measurement. However, such position sensors are cost-intensive and require additional installation space. Furthermore, each additional component in the overall system also represents an additional potential source of error.

DE 10 2022 202 224 B3 discloses a method for determining the position of an armature of an electromagnet, which makes hardware position sensors or volume flow sensors superfluous for electromagnetically actuated fluid valves with two electromagnets for actuating the fluid valve. With the method of DE 10 2022 202 224 B3, the non-actuated electromagnet of such a fluid valve can be used for position measurement and correspondingly also for position or volume flow control. As can also be seen from DE 10 2022 202 224 B3, the method taught therein is only suitable for detecting the end position of the valve element in the case of electromagnetically actuated fluid valves with only a single electromagnet for actuating the fluid valve, since the method is limited to use on a non-actuated electromagnet.

### SUMMARY

A method for implementing a data-based position sensor for an electromagnetically actuated component is provided in this disclosure.

The electromagnetically actuated component may include an armature and a coil.

The data-based position sensor may include a prediction model for the position of an electromagnetically actuated element of the electromagnetically actuated component.

The method for implementing the data-based position sensor for the electromagnetically actuated component may include generating a training data set using the electromagnetically actuated component and training the prediction model using the training data set.

Generating the training data set may include performing a test procedure on the electromagnetically actuated component and recording of input data for the prediction model in the form of time series data during the test procedure. Performing the test procedure may include generating an actuating current profile in the coil and generating a test current profile in the coil. The test current profile may comprise a variable maximum test current as a function of the actuating current profile. In one example, the variable maximum test current is at least 1% of the current actuating current and at most 10% of the current actuating current.

The input data may be the actuating current, the test current, the position of the electromagnetically actuated element, a rise time of the generated test current and/or a decay time of the generated test current. Alternatively, the input data may be the coil resistance, the maximum actuating current and/or the minimum actuating current.

In one example, the prediction model comprises an artificial neural network and has the position of the electromagnetically actuated element as its output.

In one example, the electromagnetically actuated component is an electromagnetically actuated fluid valve including a valve element and an electromagnet with the armature and the coil for actuating the valve element. The electromagnetically actuated element is the valve element.

In one example, the electromagnetically actuated component may be an electromagnet and the electromagnetically actuated element may be the armature.

In this disclosure, a method for determining the position of an armature of an individual electromagnet of a specific electromagnet type is also provided. The individual electromagnet may include the armature and a coil. The method may include implementing a data-based position sensor for an electromagnet of the specific electromagnet type, embedding the data-based position sensor in an electronic control unit associated with the individual electromagnet, generating a test current profile in the coil of the individual electromagnet, acquiring input data for the prediction model of the data-based position sensor, and determining the position of the armature of the individual electromagnet based on the acquired input data and the prediction model of the data-based position sensor.

A method for determining the position of a valve element of an individual electromagnetically actuated fluid valve of a specific fluid valve type is also provided. The individual electromagnetically actuated fluid valve may include the valve element and an electromagnet with an armature and a coil for actuating the valve element. The method may include implementing a data-based position sensor for an electromagnetically actuated fluid valve of the specific fluid valve type, embedding the data-based position sensor in an electronic control unit associated with the individual electromagnetically actuated fluid valve, generating a test current profile in the coil of the electromagnet, acquiring input data for the prediction model of the data-based position sensor, and determining the position of the valve element of the individual electromagnetically actuated fluid valve based on the acquired input data and the prediction model of the data-based position sensor.

Also provided in this disclosure is an electromagnetically actuated fluid valve of a specific fluid valve type with a valve element, an electromagnet and an integrated electronic control unit. The electromagnet may include an armature and a coil for actuating the valve element. The integrated electronic control unit may include a data-based position sensor for the electromagnetically actuated fluid valve of the specific fluid valve type. The data-based position sensor has been implemented according to the method disclosed herein.

A fluid system with an individual electromagnetically actuated fluid valve and an electronic control unit associated with the individual electromagnetically actuated fluid valve is also provided. The individual electromagnetically actuated fluid valve may include a valve element and an electromagnet with an armature and a coil for actuating the valve element. The electronic control unit may include a data-based position sensor for determining the position of the valve element. The data-based position sensor has been implemented according to the method disclosed herein.

In one aspect, the electronic control unit is integrated into the individual electromagnetically actuated fluid valve.

### BRIEF DESCRIPTION

FIG. 1 depicts a fluid system with a directly controlled electromagnetically actuated fluid valve according to an embodiment of the present disclosure;

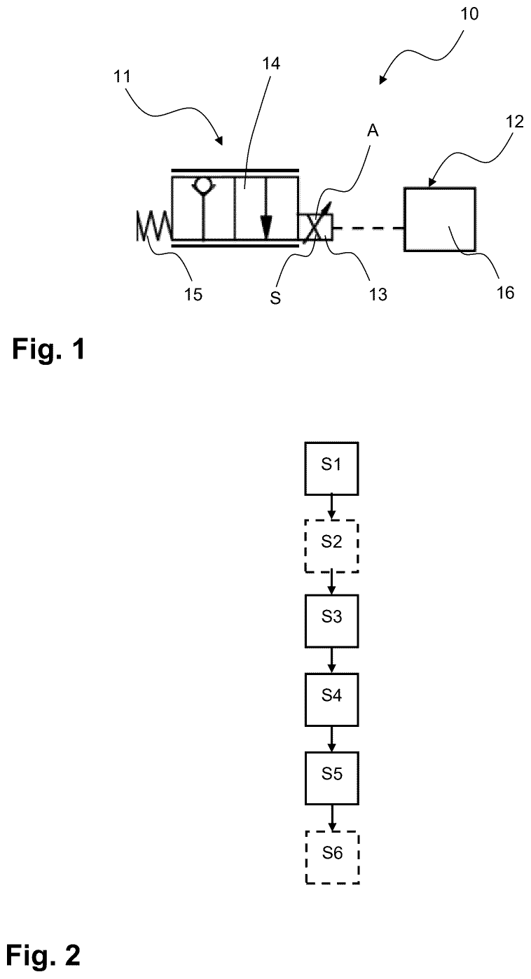

FIG. 2 is a flow chart of a method according to the disclosure;

FIG. 3 shows an exemplary diagram illustrating an actuating current profile;

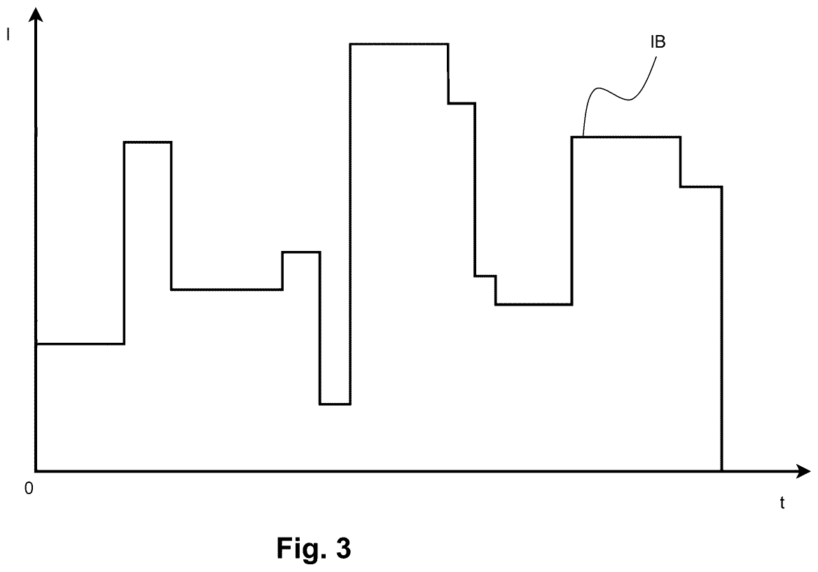

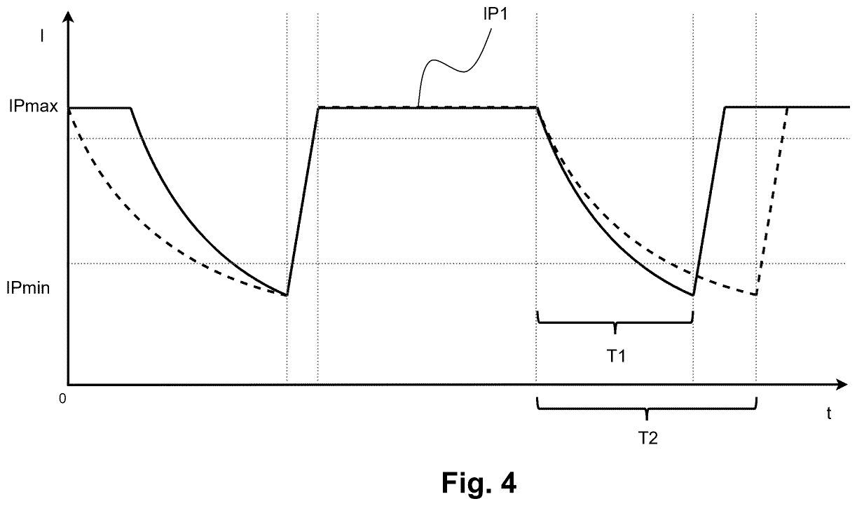

FIG. 4 shows an exemplary diagram illustrating a test current profile; and

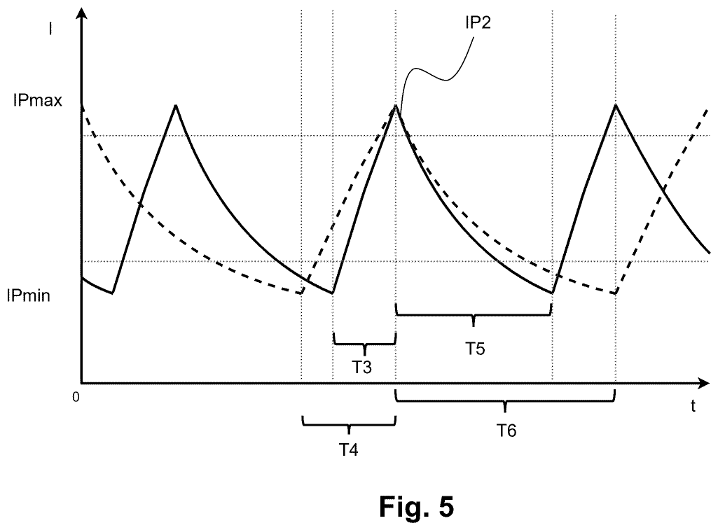

FIG. 5 shows an exemplary diagram illustrating an alternative test current profile.

### DETAILED DESCRIPTION

It is an object of the present disclosure to disclose a possibility for comprehensively monitoring the position of a valve element of an electromagnetically actuated fluid valve, which comprises only one electromagnet for actuating the valve element, which is less expensive than the known solutions, takes up less installation space and entails a reduction of risk due to component faults.

The object is initially achieved with a method for implementing a data-based position sensor for an electromagnetically actuated component. The electromagnetically actuated component may comprise an armature and a coil. The data-based position sensor may comprise a prediction model for the position of an electromagnetically actuated element of the electromagnetically actuated component.

The method according to the disclosure may comprise the following steps:
generating a training data set using the electromagnetically actuated component; and
training the prediction model using the training data set.

The electromagnetically actuated component can be an electromagnet and the electromagnetically actuated element can be the armature of the electromagnet.

Alternatively, the electromagnetically actuated component may be an electromagnetically actuated fluid valve, such as a directly controlled electromagnetically actuated hydraulic valve. The electromagnetically actuated fluid valve may comprise a valve element and an electromagnet with the armature and the coil for actuating the valve element, where the electromagnetically actuated element is the valve element.

In one aspects, the prediction model is a software-based machine learning model. By using the training data set to train a software-based prediction model of the data-based position sensor, the prediction model can be used to precisely determine the position of the electromagnetically actuated element without the need to use hardware sensors. Thus, by using the data-based position sensor, it is possible to precisely determine the position of the armature of the electromagnet even when the electromagnet is actuated. Accordingly, the position of the valve element of an electromagnetically actuated fluid valve can be determined using the actuated electromagnet by using the data-based position sensor. This means that the position of the valve element can be precisely determined without the use of hardware sensors, even in the case of electromagnetically actuated fluid valves, such as directly controlled electromagnetically actuated hydraulic valves, which only use a single electromagnet to actuate a valve element.

In some aspects, the method is configured such that generating the training data set comprises:
performing a test procedure on the electromagnetically actuated component; and
recording of input data for the prediction model in the form of time series data during the test procedure.

In some aspects, performing the test procedure and recording of the input data is done separately from the intended use of the electromagnetically actuated component, for example during production of the electromagnetically actuated component. The recording of the input data may comprise determining and soring of relevant input variables for the prediction model using hardware sensors, which are generally not available during the intended use of the electromagnetically actuated component. This means that the prediction model can be trained on the basis of the electromagnetically actuated component, which is comprehensively measured during the test procedure. During the intended use of the electromagnetically actuated component, the data-based position sensor trained in this way has less data available to determine the position of the electromagnetically actuated element due to the reduced hardware sensor technology. However, thanks to the comprehensive basis of the training data set, the data-based position sensor can also use reduced input data to precisely determine the position of the electromagnetically actuated element during the intended use.

It is also useful for performing the test procedure to comprise the following steps:
generating an actuating current profile in the coil; and
generating a test current profile in the coil.

In some aspects, the actuating current profile is in the form of APRBS signals (“Amplitude-Modulated Pseudo-Random Binary Sequence”). This means that a randomized actuating current with variable amplitude is basically generated in the coil by applying an actuating voltage to the coil in order to control a wide range of possible positions of the electromagnetically actuated element in randomized sequence and to measure the respective position of the electromagnetically actuated element.

The test current profile is generated by applying a test voltage to the coil. The test current profile preferably has a maximum test current in the range of a dither current. In other words, a maximum amplitude of the test current profile is in the range of a dither amplitude in some aspects. The use of dither signals is known from the field of continuous valves. Therein, a rectangular AC voltage signal with a low amplitude (dither amplitude) is superimposed on a DC actuating voltage in order to cause an electromagnetically actuated element (for example an armature or a valve element) to oscillate in order to avoid static friction and thus reduce hysteresis effects. The fact that the maximum test current is “in the range of a dither current” means that temporary voltage peaks above the dither amplitude can also occur, but these peaks do not lead to a significant movement of the electromagnetically actuated element due to their short duration and the inertia of the overall system. The test current profile can therefore have an amplitude that leads to small oscillatory movements of the electromagnetically actuated element, but which have no significant influence on the position of the electromagnetically actuated element.

The test current profile is preferably superimposed on the actuating current profile. Thus, the input data recorded during the test procedure contain information about the behavior of the test current profile when the electromagnetically actuated component is actuated. The test current profile may correspond to the current profiles taught in DE 10 2022 202 224 B3.

In some aspects, if the test current profile comprises a variable maximum test current as a function of the actuating current profile, where the variable maximum test current is at least 1% of the current actuating current and at most 10% of the current actuating current. Alternatively, the variable maximum test current is at least 2% of the current actuating current and at most 6% of the current actuating current. Since the test current profile is superimposed on the actuating current profile, it is important to ensure that the test current is not so small that it is lost in the actuating signal. On the other hand, the test current must not be so high that it causes a significant actuation of the electromagnetically actuated component. This is achieved by the specified limit values.

In one aspect, the input data comprises the actuating current, the test current, the position of the electromagnetically actuated element, a rise time of the generated test current and/or a decay time of the generated test current. The rise time and/or the decay time of the test current generally allow conclusions to be drawn about the position of the electromagnetically actuated element. However, due to the superimposition of the test current with the actuating current in a single coil, there is no longer a simple analytically solvable relationship. By recording the input data for the prediction model in the form of time series data during the test procedure and then using it to train the prediction model, the prediction model can identify and store the dynamics of the underlying processes and later use them to predict the position of the electromagnetically actuated element (e.g. the armature or the valve element, respectively) on the basis of reduced input data during the intended use of the electromagnetically actuated component.

In one aspect, the input data also includes the coil resistance, the maximum actuating current and/or the minimum actuating current. The more input data is available for training the prediction model, the more accurately the data-based position sensor will function. For example, the coil resistance can be used for temperature compensation.

In one aspect, the method also comprises the following step before training the prediction model: cleaning and filtering the training data set. This allows measurement errors that occurred during generating the training data set to be removed from the training data set, thereby improving the accuracy of the prediction model.

In one aspect, the prediction model comprises an artificial neural network and has as output the position of the electromagnetically actuated element. In one aspect, the prediction model is a NARX model (nonlinear autoregressive exogenous model), an ANARX model (additive nonlinear autoregressive exogenous model), an LSTM model (long short-term memory model), an ARIMA model (auto-regressive integrated moving average model), a Naive Bayes model or an autoencoder model. These machine learning models based on artificial neural networks can be selected depending on the data basis available for the intended use, available computing power and existing accuracy requirements.

Furthermore, the object is achieved by a method according to the disclosure for determining the position of an armature of an individual electromagnet of a specific electromagnet type, where the individual electromagnet comprises the armature and a coil. The method may comprise the following steps:
implementing a data-based position sensor for an electromagnet of the specific electromagnet type by the method described above;
embedding the data-based position sensor in an electronic control unit associated with the individual electromagnet;
generating a test current profile in the coil of the individual electromagnet;
acquiring input data for the prediction model of the data-based position sensor; and
determining the position of the armature of the individual electromagnet based on the acquired input data and the prediction model of the data-based position sensor.

In one aspect, the input data includes at least the current actuating current, the generated test current and the rise time and/or the decay time of the test current.

Basically, there are structural deviations between each individual electromagnet of the same electromagnet type due to series production variations. Accordingly, each individual electromagnet of the same electromagnet type is an individually unique electromagnet. These manufacturing-related structural deviations or uniqueness cause the real behavior of each individual electromagnet of a specific electromagnet type to deviate slightly from the real behavior of each other individual electromagnet of the same electromagnet type and thus also from the ideal behavior. However, a data-based position sensor implemented by the method described above using an individual electromagnet of a specific electromagnet type is able to provide sufficiently accurate results for the position of the armature of the electromagnet for other individual electromagnets of the same electromagnet type. Accordingly, by implementing the data-based position sensor once for an electromagnet of the specific electromagnet type, the position of the armature of any other individual electromagnet of the same electromagnet type can be determined with sufficient accuracy.

Furthermore, the object is achieved by a method according to the disclosure for determining the position of a valve element of an individual electromagnetically actuated fluid valve of a specific fluid valve type, such as a specific hydraulic valve type, where the individual electromagnetically actuated fluid valve comprises the valve element and an electromagnet with an armature and a coil for actuating the valve element. The method may comprise the following steps:
implementing a data-based position sensor for an electromagnetically actuated fluid valve of the specific fluid valve type by the method described above;
embedding the data-based position sensor in an electronic control unit associated with the individual electromagnetically actuated fluid valve; generating a test current profile in the coil of the electromagnet;
acquiring input data for the prediction model of the data-based position sensor; and
determining the position of the valve element of the individual electromagnetically actuated fluid valve based on the acquired input data and the prediction model of the data-based position sensor.

In one aspect, the input data includes at least the current actuating current, the generated test current and the rise time and/or the decay time of the test current.

Basically, there are structural deviations between each individual electromagnetically actuated fluid valve of the same fluid valve type due to production variations. Accordingly, each individual electromagnetically actuated fluid valve of the same fluid valve type is an individually unique fluid valve. These manufacturing-related structural deviations or uniqueness cause the real behavior of each individual electromagnetically actuated fluid valve of a specific fluid valve type to deviate slightly from the real behavior of each other individual electromagnetically actuated fluid valve of the same fluid valve type, and thus also from the ideal behavior. However, a data-based position sensor implemented by the method described above using an individual electromagnetically actuated fluid valve of a specific fluid valve type is able to provide sufficiently accurate results for the position of the valve element also for other individual electromagnetically actuated fluid valves of the same fluid valve type. Accordingly, by implementing the data-based position sensor once for an electromagnetically actuated fluid valve of the specific fluid valve type, the position of the valve element of any other individual electromagnetically actuated fluid valve of the same fluid valve type can be determined with sufficient accuracy.

Furthermore, the object is achieved with an electromagnetically actuated fluid valve, such as a directly controlled electromagnetically actuated hydraulic valve, of a specific fluid valve type with a valve element, an electromagnet and an integrated electronic control unit, where the electromagnet comprises an armature and a coil for actuating the valve element, wherein the integrated electronic control unit comprises a data-based position sensor for the electromagnetically actuated fluid valve of the specific fluid valve type, where the data-based position sensor has been implemented by the method described above.

With the electromagnetically actuated fluid valve with integrated electronic control unit according to the disclosure, it is possible to precisely determine the position of the valve element of the electromagnetically actuated fluid valve without the use of hardware sensors. Consequently, with the electromagnetically actuated fluid valve according to the disclosure, it is possible to implement a position control for the valve element and/or a volume flow control for the individual electromagnetically actuated fluid valve using the data-based position sensor. Because the data-based position sensor is embedded in the integrated electronic control unit, the individual electromagnetically actuated fluid valve can already be equipped with the data-based position sensor during production. The electromagnetically actuated fluid valve according to the disclosure therefore provides the aforementioned functionalities without having to rely on the additional hardware sensors that were previously necessary.

Furthermore, the object is achieved with a fluid system according to the disclosure, such as a hydraulic system, with an individual electromagnetically actuated fluid valve, such as an individual directly controlled electromagnetically actuated hydraulic valve, and an electronic control unit associated with the individual electromagnetically actuated fluid valve, where the individual electromagnetically actuated fluid valve comprises a valve element and an electromagnet with an armature and a coil for actuating the valve element. The electronic control unit comprises a data-based position sensor for determining the position of the valve element, where the data-based position sensor has been implemented by the method described above.

With the fluid system according to the disclosure, it is possible to precisely determine the position of the valve element without the use of hardware sensors. As a result, position control for the valve element and/or volume flow control for the individual electromagnetically actuated fluid valve can be implemented in the electronic control unit using the data-based position sensor.

In one aspect, the electronic control unit is integrated into the individual electromagnetically actuated fluid valve. This means that the individual electromagnetically actuated fluid valve can already be equipped with the data-based position sensor during production.

FIG. 1 shows a fluid system 10, in the present case a hydraulic system, according to an exemplary embodiment of the present disclosure. The fluid system 10 comprises an individual electromagnetically actuated fluid valve 11. In the present case, the fluid valve 11 is a hydraulic valve, more specifically a directly controlled electromagnetically actuated proportional 2/2-way poppet valve with an electromagnet 13 and a valve element 14 as well as a biasing device 15, which is shown here as a spring element by way of example. In a generally known manner, the electromagnet 13 comprises an armature A and a coil S. By energizing the coil S, the armature A, which is directly connected, for example via an actuating rod, to the valve element 14, moves and thus actuates the fluid valve 11.

For a skilled person in the field of hydraulics, it is clear that the directly controlled electromagnetically actuated proportional 2/2-way poppet valve here is an example of an electromagnetically actuated fluid valve 11 of a specific fluid valve type. The electromagnetically actuated fluid valve 11 could also be any other electromagnetically actuated fluid valve, for example a spool valve or a binary switching valve. In particular, it is also not necessary for the electromagnetically actuated fluid valve 11 to comprise only an electromagnet 13 for actuating the valve element 14. A data-based position sensor 16 described below can also be used with an electromagnetically actuated fluid valve 11 with two complementary electromagnets 13, only one of which is energized to actuate the valve element 14.

It is also clear to those skilled in the art of hydraulics that, for the purposes of the present disclosure, the electromagnetically actuated fluid valve 11 is an example of an electromagnetically actuated component and the valve element 14 is an example of an electromagnetically actuated element. Similarly, it is clear that for the purposes of the present disclosure, the electromagnet 13 is an example of an electromagnetically actuated component and the armature A of the electromagnet 13 is an example of an electromagnetically actuated element.

The exemplary fluid system 10 according to FIG. 1 further comprises an electronic control unit 12, which is associated with the electromagnetically actuated fluid valve 11 in order to energize the electromagnet 13 for actuating the electromagnetically actuated fluid valve 11.

In this embodiment, the electronic control unit 12 is integrated into the electromagnetically actuated fluid valve 11. The electronic control unit 12 comprises the data-based position sensor 16.

In the following, a method according to the disclosure for implementing the data-based position sensor 16 for the electromagnetically actuated fluid valve 11 is described with reference to FIGS. 2 to 5.

In step S1, a training data set is first generated using an electromagnetically actuated fluid valve of the same fluid valve type as the individual electromagnetically actuated fluid valve 11. The training data set does not necessarily have to be generated using the individual electromagnetically actuated fluid valve 11 of the fluid system 10 itself. Due to the sufficient comparability of the dynamics of individual fluid valves of the same fluid valve type, it is sufficient to generate the training data set using any individual fluid valve of the same fluid valve type.

For generating the training data set, a test procedure is performed on the electromagnetically actuated fluid valve 11 in step S1. During the test procedure, input data for a prediction model of the data-based position sensor 16 is recorded in the form of time series data.

The test procedure comprises the generating of an actuating current profile in the coil S of the electromagnet 13 and the generating of a test current profile in the coil S of the electromagnet 13.

FIG. 3 shows an exemplary actuating current profile IB over time t. It can be clearly seen here that the actuating current profile IB is an APRBS signal in which each randomized amplitude jump of the current I corresponds to a switching operation, i.e. a change in position, of the valve element 14. More precisely, each amplitude jump of the current I of the actuating current profile IB generated in the coil S corresponds to a position change of the armature A in the coil S and thus a position change of the valve element 14 directly connected to the armature A.

FIG. 4 shows an exemplary first test current profile IP1 over the time t. In the first test current profile IP1 in FIG. 4, the test current is increased up to a defined maximum test current IPmax, held at the maximum test current IPmax and then the voltage for generating the test current profile IP1 is switched off. This causes the test current to decay without external voltage influence. The inductance of the coil S varies depending on how far the armature A is inside the coil S, i.e. the current position of the valve element 14, which is why the decay time of the test current varies without external voltage influence. FIG. 4 shows an example of a first decay time T1 and a second decay time T2, each of which represents the time required by the test current to drop from its defined maximum value IPmax to a defined minimum value IPmin. The longer second decay time T2 (dashed curve in FIG. 4) corresponds to a case in which the armature A is located further inside the coil S, i.e. the inductance of the coil S is higher than in the case of the shorter decay time T1 (solid curve in FIG. 4). The position of the valve element 14 in the electromagnetically actuated fluid valve 11 can be derived from this relationship.

FIG. 5 shows an alternative second test current profile IP2, which also alternates between a defined maximum test current IPmax and a defined minimum test current IPmin. In the second test current profile IP2 in FIG. 5, however, the test current is not held at its maximum value IPmax, but the voltage at the coil S is directly switched off when the maximum test current IPmax is reached. Another difference to the first test current profile IP1 in FIG. 4 is that in the second test current profile IP2 in FIG. 5, the increase of the test current is not brought to the maximum test current IPmax in the form of rapid regulation. Instead, in the second test current profile IP2, the rise time of the test current is also dependent on the position of the armature A in the coil S, resulting in a shorter first rise time T3 (solid curve in FIG. 5) and a longer second rise time T4 (dashed curve in FIG. 5) for the two exemplary curves shown in FIG. 5. Analogous to FIG. 4, there is also a shorter third decay time T5 and a longer fourth decay time T6. The rise time and the decay time of the test current are a measure of the position of the armature A within the coil S and the position of the valve element 14 in the electromagnetically actuated fluid valve 11.

During step S1, a test current profile IP1, IP2 is therefore superimposed on the actuating current profile IB. The maximum test current IPmax and the minimum test current IPmin are variable depending on the currently generated (current) actuating current. The maximum test current IPmax and the minimum test current IPmin may be in a range of 1% to 10% of the current actuating current, or in a range of 2% to 6% of the current actuating current. For example, the maximum test current IPmax is in the range of a dither current of the electromagnetically actuated fluid valve 11. On the one hand, this ensures that the test current is large enough not to be lost in the actuating current signal, i.e. that the test current can still be detected. On the other hand, it is also ensured that the test current is so low that it does not cause any significant actuation of the armature A or the valve element 14, so that the volume flow flowing via the electromagnetically actuated fluid valve 11 is not significantly influenced, as is generally known when dither signals are used.

In FIG. 3, each step of the actuating current profile IB corresponds to a switching position of the valve element 14 in the electromagnetically actuated fluid valve 11. During the test procedure, the frequency of the respective test current profile IP1, IP2 and the actuating current profile IB must be matched to one another, so that at least one cycle of the test current profile IP1, IP2 is run through during one switching position of the electromagnetically actuated fluid valve 11 under the actuating current profile IB.

During the test procedure described, all available data is recorded as time series data in order to be available as input data for the prediction model of the data-based position sensor 16. In particular, the input data includes the actuating current IB, the test current IP1, IP2, the position of the armature A and/or the valve element 14 and the decay time of the test current T1, T2, T5, T6. If the second test current profile IP2 is used, the rise time T3, T4 of the test current is also recorded. In addition, the coil resistance, the maximum actuating current, the minimum actuating current, the voltage applied to generate the actuating current profile IB and the voltage applied to generate the test current profile IP1, IP2 are also recorded as time series data during the test procedure so that they can subsequently be used as input data for the prediction model.

During the test procedure, the position of armature A and/or valve element 14 is precisely recorded using hardware sensors. This provides the prediction model of the data-based position sensor 16 with a well-founded training data set so that it can later be used as a precise position sensor for the electromagnetically actuated fluid valve 11.

In the optional step S2, the training data set can be filtered and/or cleaned after the training data set has been created in step S1 in order to remove measurement errors that may have occurred during the test procedure.

In step S3, the prediction model of the data-based position sensor 16 is then trained using the recorded training data set. The prediction model may comprise an artificial neural network in the form of a NARX (nonlinear autoregressive exogenous) or ANARX model (additive nonlinear autoregressive exogenous model), which has the position of the armature A or the valve element 14, respectively, as its output.

After completing step S3, the implementation of the data-based position sensor 16 is complete.

In step S4, the data-based position sensor 16 is now embedded in the electronic control unit 12, which is associated with the electromagnetically actuated fluid valve 11. In the present case, the electronic control unit 12 is integrated into the electromagnetically actuated fluid valve 11, so the electronic control unit 12 and the electromagnetically actuated fluid valve 11 form a structural unit. Alternatively, however, the fluid system 10 can also comprise a central electronic control unit which is associated with the electromagnetically actuated fluid valve 11 or is configured to control the electromagnetically actuated fluid valve 11, respectively.

Finally, in step S5, the data-based position sensor 16 is used to determine the position of the valve element 14 of the electromagnetically actuated fluid valve 11. For this purpose, when the electromagnetically actuated fluid valve 11 is put to its intended use in the fluid system 10, a test current profile IP1, IP2 is generated by the electronic control unit 12 in the coil S of the electromagnet 13 as a function of the current actuating current of the electromagnetically actuated fluid valve 11. The course of the test current generated by the electronic control unit 12 and the current actuating current are made available to the data-based position sensor 16 as input data, whereupon the data-based position sensor 16 outputs the current position of the valve element 14.

Furthermore, in step S5, the electronic control unit 12 can use the position of the valve element 14 determined by the data-based position sensor 16 to implement a path control for the valve element 14 and/or a volume flow control for the volume flow flowing via the electromagnetically actuated fluid valve 11, depending on the requirements.

Finally, in an optional step S6, the data-based position sensor 16 can be updated or fine-tuned. For this purpose, steps S1 to S4 can, for example, be repeated using the individual electromagnetically actuated fluid valve 11 as part of a test procedure adapted to the actual application environment of the individual electromagnetically actuated fluid valve 11 in the fluid system 10 in order to obtain a particularly accurate training data set for the data-based position sensor 16.

What is claimed is:

1. A method for implementing a data-based position sensor for an electromagnetically actuated component, wherein the electromagnetically actuated component comprises an armature and a coil, wherein the data-based position sensor comprises a prediction model for a position of an electromagnetically actuated element of the electromagnetically actuated component, the method comprising:
generating a training data set using the electromagnetically actuated component; and
training the prediction model using the training data set.

2. The method according to claim 1, wherein generating the training data set comprises:
performing a test procedure on the electromagnetically actuated component; and
recording of input data for the prediction model in the form of time series data during the test procedure.

3. The method according to claim 2, wherein performing the test procedure comprises:
generating an actuating current profile in the coil; and
generating a test current profile in the coil.

4. The method according to claim 3, wherein the test current profile comprises a variable maximum test current as a function of the actuating current profile, wherein the variable maximum test current is at least 1% of the current actuating current and is at most 10% of the current actuating current.

5. The method according to claim 3, wherein the input data comprises the actuating current, the test current profile, the position of the electromagnetically actuated element, a rise time of the generated test current profile and/or a decay time of the generated test current profile.

6. The method according to claim 2, wherein the input data comprises a coil resistance, a maximum actuating current and/or a minimum actuating current.

7. The method according to claim 1, wherein the prediction model comprises an artificial neural network and has the position of the electromagnetically actuated element as its output.

8. The method according to claim 1, wherein the electromagnetically actuated component is an electromagnet and the electromagnetically actuated element is the armature.

9. The method according to claim 1, wherein the electromagnetically actuated component is an electromagnetically actuated fluid valve, wherein the electromagnetically actuated fluid valve comprises a valve element and an electromagnet with the armature and the coil for actuating the valve element, wherein the electromagnetically actuated element is the valve element.

10. A method for determining a position of an armature of an individual electromagnet of a specific electromagnet type, wherein the individual electromagnet comprises the armature and a coil, the method comprising:
implementing a data-based position sensor for an electromagnet of the specific electromagnet type by the method according to claim 8;
embedding the data-based position sensor in an electronic control unit associated with the individual electromagnet;
generating a test current profile in the coil of the individual electromagnet;
acquiring input data for the prediction model of the data-based position sensor; and
determining the position of the armature of the individual electromagnet based on the acquired input data and the prediction model of the data-based position sensor.

11. A method for determining a position of a valve element of an individual electromagnetically actuated fluid valve of a specific fluid valve type, wherein the individual electromagnetically actuated fluid valve comprises the valve element and an electromagnet with an armature and a coil for actuating the valve element, the method comprising:
implementing a data-based position sensor for an electromagnetically actuated fluid valve of the specific fluid valve type by the method according to claim 9;
embedding the data-based position sensor in an electronic control unit associated with the individual electromagnetically actuated fluid valve;
generating a test current profile in the coil of the electromagnet;
acquiring input data for the prediction model of the data-based position sensor; and
determining the position of the valve element of the individual electromagnetically actuated fluid valve based on the acquired input data and the prediction model of the data-based position sensor.

12. An electromagnetically actuated fluid valve of a specific fluid valve type with a valve element, an electromagnet and an integrated electronic control unit, wherein the electromagnet comprises an armature and a coil for actuating the valve element, wherein the integrated electronic control unit comprises a data-based position sensor for the electromagnetically actuated fluid valve of the specific fluid valve type, wherein the data-based position sensor has been implemented by the method according to claim 9.
